(19) United States
(12) Patent Application Publication
(10) Pub. No.: US 2020/0343804 A1
(43) Pub. Date: Oct. 29, 2020

(54) MULTI-STAGE SPHERICAL MOTOR

(71) Applicant: HONEYWELL INTERNATIONAL INC., Morris Plains, NJ (US)

(72) Inventors: Deepak Pitambar Mahajan, Bangalore (IN); Subhashree Rajagopal, Bangalore (IN); Sivanagamalleswara Bavisetti, Bangalore (IN); Renukaprasad N, Bangalore (IN)

(73) Assignee: HONEYWELL INTERNATIONAL INC., Morris Plains, NJ (US)

(21) Appl. No.: 16/553,020

(22) Filed: Aug. 27, 2019

(30) Foreign Application Priority Data
Apr. 26, 2019 (IN) 201941016743

(51) Int. Cl. H02K 41/06; B64C 27/32; B64D 27/24

(52) U.S. Cl. CPC H02K 41/065; B64C 27/32; B64C 39/024; B64C 2201/108; B64C 2201/042; B64D 27/24

(57) ABSTRACT

A multi-stage spherical motor includes an inner stator, an outer stator, a rotor, and magnets. The inner stator has a plurality of inner stator windings wound thereon. The outer stator is spaced apart from and at least partially surrounds the inner stator, and has a plurality of outer stator windings wound thereon. The rotor is disposed between the inner stator and the outer stator and is configured to rotate about a plurality of perpendicular axes. The rotor has an inner surface and an outer surface. An inner array of magnets is coupled to the inner surface of the rotor, and an outer array of magnets coupled to the outer surface of the rotor. In some embodiments, a multi-stage spherical motor includes an inner rotor, an outer rotor, a stator, inner stator coils, and outer stator coils.

### CROSS-REFERENCE TO RELATED APPLICATION

The present application claims benefit of prior-filed Indian Provisional Patent Application 201941016743, filed Apr. 26, 2019, which is hereby incorporated by reference herein in its entirety.

### TECHNICAL FIELD

The present invention generally relates to spherical motors, and more particularly relates to a multi-stage spherical motor.

### BACKGROUND

Recent developments in the field of UAV (Unmanned Aerial Vehicles), drones for unmanned air transport, robotics, office automation, and intelligent flexible manufacturing and assembly systems have necessitated the development of precision actuation systems with multiple degrees of freedom (DOF). Conventionally, applications that rely on multiple (DOF) motion have typically done so by using a separate motor/actuator for each axis, which results in complicated transmission systems and relatively heavy structures.

With the advent of spherical motors, there have been multiple attempts to replace the complicated multi-DOF assembly with a single spherical motor assembly. A typical spherical motor consists of a central sphere on which coils are wound, which may be orthogonally placed from each other. The sphere is surrounded by multi-pole magnets in the form of an open cylinder. The coil assembly is held axially and maintained in a vertical position via, for example, a metal post. The outer cylinder is held by a yoke/frame via a bearing, which allows the cylinder to be rotatable about its axis. The yoke is further connected to the metal post of the coil assembly via a second bearing, which allows the yoke, along with the cylinder, to be rotatable about one or two additional axes.

Unfortunately, current attempts to apply the spherical motor to the certain applications, such as UAVs and robotics, have led to several spherical motor design concepts. Unfortunately, many of these design concepts suffer certain drawbacks. For example, many have limited power density (e.g., power-to-weight ratio).

Hence, there is a need for a spherical motor that at least exhibits a power density greater than presently known spherical motors. The present invention addresses at least this need.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

In one embodiment, a multi-stage spherical motor includes an inner stator, an outer stator, a rotor, and magnets. The inner stator has a plurality of inner stator windings wound thereon. The outer stator is spaced apart from and at least partially surrounds the inner stator, and has a plurality of outer stator windings wound thereon. The rotor is disposed between the inner stator and the outer stator and is configured to rotate about a plurality of perpendicular axes. The rotor has an inner surface and an outer surface. An inner array of magnets is coupled to the inner surface of the rotor, and an outer array of magnets coupled to the outer surface of the rotor.

In another embodiment, a multi-stage spherical motor includes an inner rotor, an outer rotor, a stator, inner stator coils, and outer stator coils. The inner rotor is configured to rotate and has an inner surface and an outer surface. The outer rotor is spaced apart from and at least partially surrounds the inner rotor. The outer rotor is configured to rotate with the inner rotor and has an inner surface and an outer surface. An inner array of magnets is coupled to the outer surface of the inner rotor, and an outer array of magnets is coupled to the inner surface of the outer rotor. The stator is disposed between the inner rotor and the outer rotor, and has a stator inner surface and a stator outer surface. The inner stator coils are wound on the stator inner surface and the outer stator coils are wound on the stator outer surface.

In yet another embodiment, a multi-stage spherical motor includes an inner stator, an outer stator, a rotor, an inner array of magnets, and an outer array of magnets. The inner stator has a plurality of inner stator windings wound thereon, and comprises an inner stator iron backing and a plurality of arc-shaped inner stator poles, where each arc-shaped inner stator pole is connected to the inner stator iron backing. The outer stator is spaced apart from and at least partially surrounds the inner stator. The outer stator has a plurality of outer stator windings wound thereon, and comprises an outer stator iron backing and a plurality of arc-shaped outer stator poles, where each arc-shaped outer stator pole is connected to the outer stator iron backing. The rotor is disposed between the inner stator and the outer stator and is configured to rotate about a plurality of perpendicular axes, and has an inner surface and an outer surface. The inner array of magnets is coupled to the inner surface of the rotor, and the outer array of magnets is coupled to the outer surface of the rotor. The plurality of inner stator windings comprise (i) a plurality of inner stator distributed windings and (ii) an inner stator voice coil winding, the plurality of outer stator windings comprise (i) a plurality of outer stator distributed windings and (ii) an outer stator voice coil winding wound thereon, the inner stator voice coil winding is disposed on an outer surface of the inner stator, and the outer stator voice coil winding is disposed on an inner surface of the outer stator.

Furthermore, other desirable features and characteristics of the multi-stage spherical motor will become apparent from the subsequent detailed description and the appended claims, taken in conjunction with the accompanying drawings and the preceding background.

### BRIEF DESCRIPTION OF THE DRAWINGS

The present invention will hereinafter be described in conjunction with the following drawing figures, wherein like numerals denote like elements, and wherein:

FIG. 1 depicts a cross section view of one embodiment of a multi-stage spherical motor;

FIG. 2 depicts a plan view, in more detail, of various portions of the motor of FIG. 1;

FIG. 3 depicts an exploded view of the motor depicted in FIG. 2;

FIG. 4 depicts a plan view of one embodiment of a rotor that may be used to implement the motor of FIGS. 1-3;

FIG. 5 depicts a plan view of another embodiment of stators and a rotor that may be used to implement a multi-stage spherical motor;

FIG. 6 depicts an exploded view of the embodiment depicted in FIG. 5;

FIG. 7 depicts a cross section view of another embodiment of a multi-stage spherical motor; and

FIG. 8 graphically depicts a comparison of torque generated by a currently known spherical motor and an embodiment of a multi-stage spherical motor.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

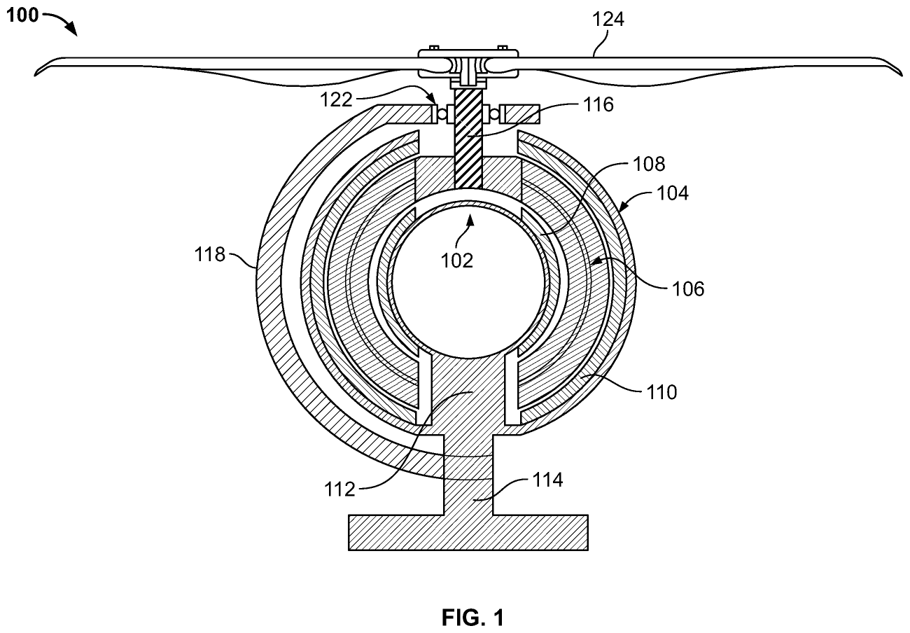

An example embodiment of a two-stage spherical motor 100 implemented in one envisioned end-use implementation is depicted in FIG. 1. The two-stage spherical motor 100 and includes an inner stator 102, an outer stator 104, and a rotor 106. The inner and outer stators 102, 104 each have a plurality of coils wound thereon. Specifically, the inner stator 102 has a plurality of inner stator coils 108 wound thereon, and the outer stator 104 has a plurality of outer stator coils 110 wound thereon. The inner and outer stator coils 108, 110 are described in more detail further below. In the depicted embodiment, the inner and outer stators 102, 104 are mechanically coupled to each other via a connecting shaft 112 that is in turn coupled to a mounting support 114. The mounting support 114 is configured to fixedly couple the motor 100 to a non-illustrated structure/external payload.

The rotor 102 is coupled to a load shaft 116, which is rotationally mounted to a support 118 via a bearing assembly 122. As a result, the rotor 106 and load shaft 116 are rotatable relative to the inner and outer stators 102, 104. A payload 124 may be coupled to the load shaft 116 and rotated therewith. In the embodiment depicted in FIG. 1, the payload 124 is a propeller. In other embodiments, the payload 124 may be any one of numerous devices that are configured to receive a torque and spin/rotate for limited turns/by predetermined angle.

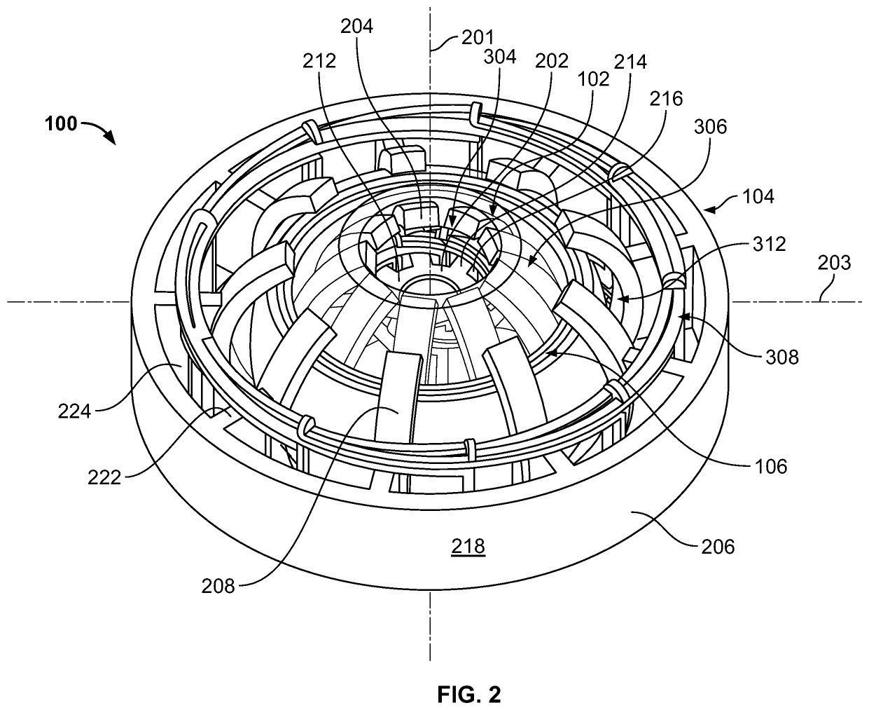

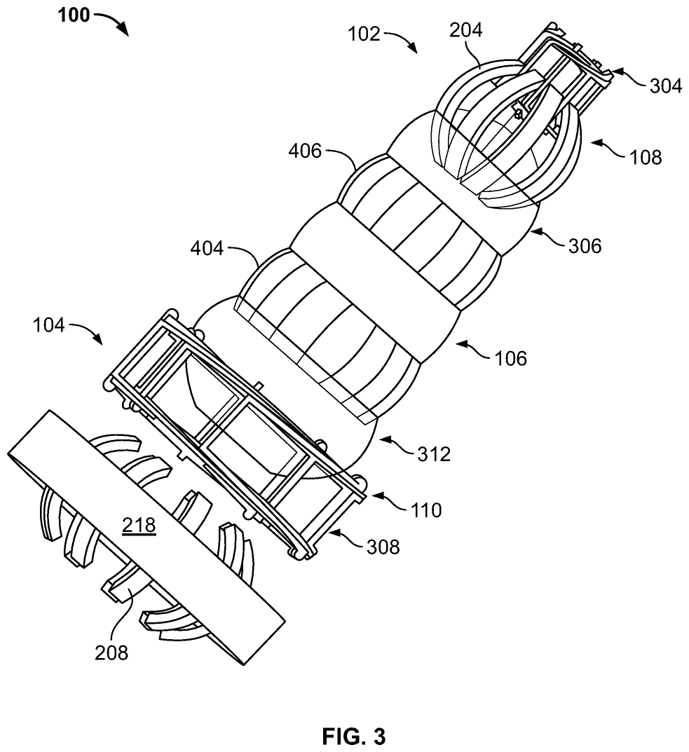

The inner stator 102 and outer stator 104 may each be constructed as a unitary structure or from two or more structures. In the depicted embodiment, however, the inner and outer stators 102, 104 are both formed as unitary structures, and each includes an iron backing and a plurality of arc-shaped poles that are spaced apart from each other. More specifically, and with reference now to FIGS. 2 and 3, it is seen that the inner stator 102 includes an inner stator iron backing 202 and a plurality of arc-shaped inner stator poles 204, and the outer stator 104 includes an outer stator iron backing 206 and a plurality of arc-shaped outer stator poles 208.

The inner stator iron backing 202 includes an inner main body 212 and a plurality of inner spokes 214. The inner spokes 214 extend radially outwardly from the inner main body 212 and are spaced-apart from each other to define a plurality of inner stator slots 216. Each of the arc-shaped inner stator poles 204 is directly connected to a different one of the inner spokes 214. The outer stator iron backing 206 includes an outer main body 218 and a plurality of outer spokes 222. The outer spokes 222 extend radially inwardly from the outer main body 218 and are spaced-apart from each other to define a plurality of outer stator slots 224. Each of the arc-shaped outer stator poles 208 is directly connected to a different one of the outer spokes 222.

As may be appreciated the iron backing 202, 206 provides a low reluctance path for the magnetic flux that is generated when the coils (described momentarily) are electrically energized. The iron backing 202, 206 and associated spokes 214, 222 may be constructed of any one of numerous known materials. Some non-limiting examples include relatively soft magnetic solid material, steel stampings/laminations, and molds made up of soft iron powder and/or composites. As may also be appreciated, the arc-shape and spacing of the inner and outer poles 204, 208 define the shapes of the inner and outer stators 102, 104 as being spherically shaped.

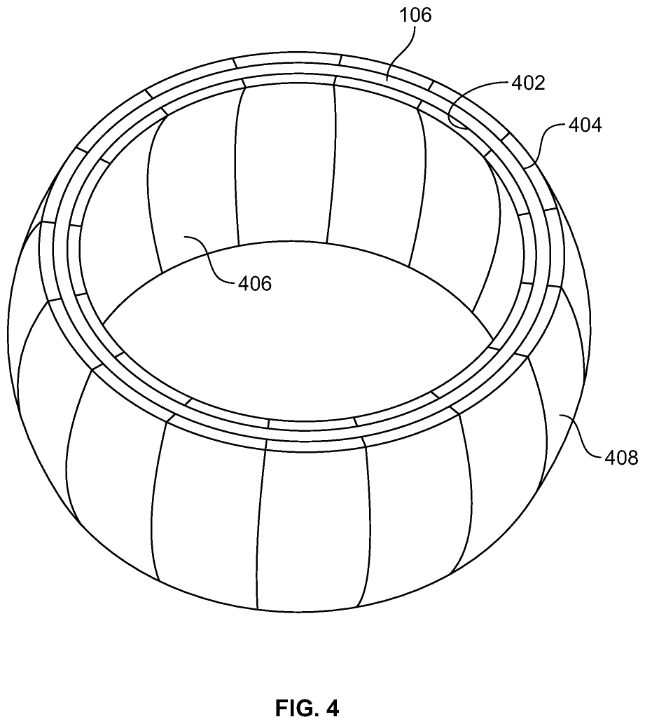

Turning now to the rotor 106, an embodiment of which is shown more clearly in FIG. 4, it is seen that it is also spherically shaped (or at least partially spherically shaped). Regardless of its shape, the rotor 106 includes an inner surface 402 and an outer surface 404 and is disposed between the inner and outer stators 102, 104. More specifically, as shown in FIGS. 1 and 2, the rotor 106 is at least partially surrounded by the outer stator 104, and the rotor 106 at least partially surrounds the inner stator 102. The rotor 106 may comprise any one of numerous magnetic or non-magnetic materials.

As FIG. 4 also depicts, the rotor 106 additionally includes a plurality of magnets—an inner array of magnets 406 and an outer set of magnets 408. The inner array of magnets 406 is coupled to the inner surface 402 of the rotor 106, and the outer array of magnets 408 is coupled to the outer surface 404 of the rotor 106. The inner and outer arrays of magnets 406, 408 may be variously configured. For example, each may be permanent magnets configured as a Halbach array or as a non-Halbach array.

Returning now to FIGS. 2 and 3, it is seen that the the inner stator coils 108 and the outer stator coils 110 each include two sets of coil windings—distributed windings and a voice coil winding. More specifically, the inner stator coils 108 include inner stator distributed windings 304 and an inner stator voice coil winding 306, and the outer stator coils 110 include outer stator distributed windings 308 and an outer stator voice coil winding 312. The inner stator distributed windings 304 extend through the inner stator slots 216 and may be wound in either concentrated or distributed fashion within these slots 216. The inner stator voice coil winding 306 is wound onto and around the outer surface 314 (see FIG. 3) of the arc-shaped inner stator poles 204. The outer stator distributed windings 308 extend through the outer stator slots 224 and, like the inner stator distributed windings 304, may be wound in either concentrated or distributed fashion within these slots 224. The outer stator voice coil winding 312 is wound onto and around the inner surface 316 (see FIG. 3) of the arc-shaped outer stator poles 208. In the depicted embodiment, it is noted that the inner and outer stator distributed windings 304, 308 are implemented as 3-phase windings. In other embodiments, the windings 304, 308 may be implemented with N-number of phases, where N is an integer greater than or less than three.

Regardless of the number of phases, the inner and outer stator distributed windings 304, 308, when energized, are used for spinning the rotor 106 relative to the inner and outer stators 102, 104, and the inner and outer stator voice coil windings 306, 312, when energized, are used for tilting the rotor 106 relative to the inner and outer stators 102, 104. That is, and with reference to FIG. 2, the inner and outer stator distributed windings 304, 308, when energized, impart a torque to the rotor 106 that causes it to rotate, relative to the inner and outer stators 102, 104, about a first rotational axis 201 (e.g., spin axis). The inner and outer stator voice coil windings 306, 312, when energized, impart a torque to the rotor 106 that causes it to rotate, relative to the inner and outer stators 102, 104, about a second rotational axis 203 (e.g., tilt axis) that is perpendicular to the first rotational axis 201.

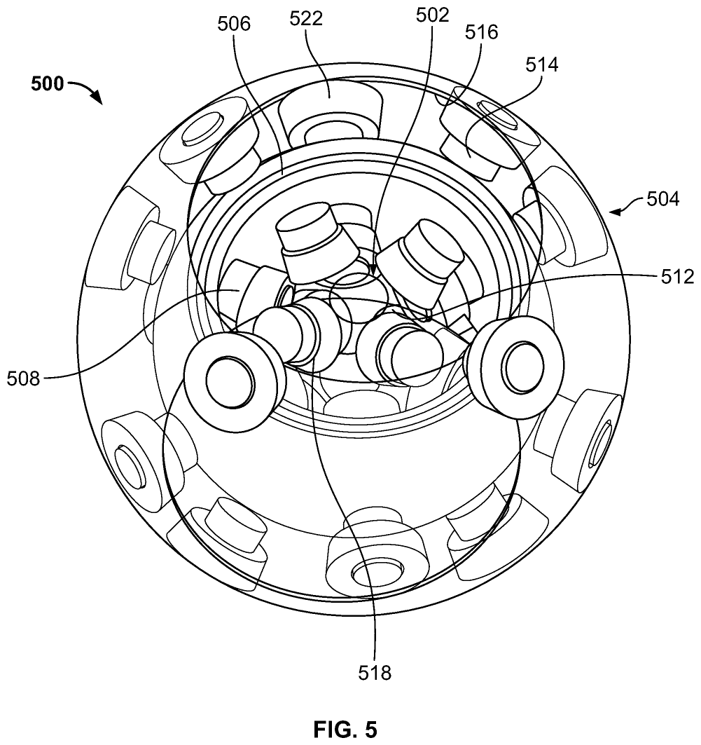

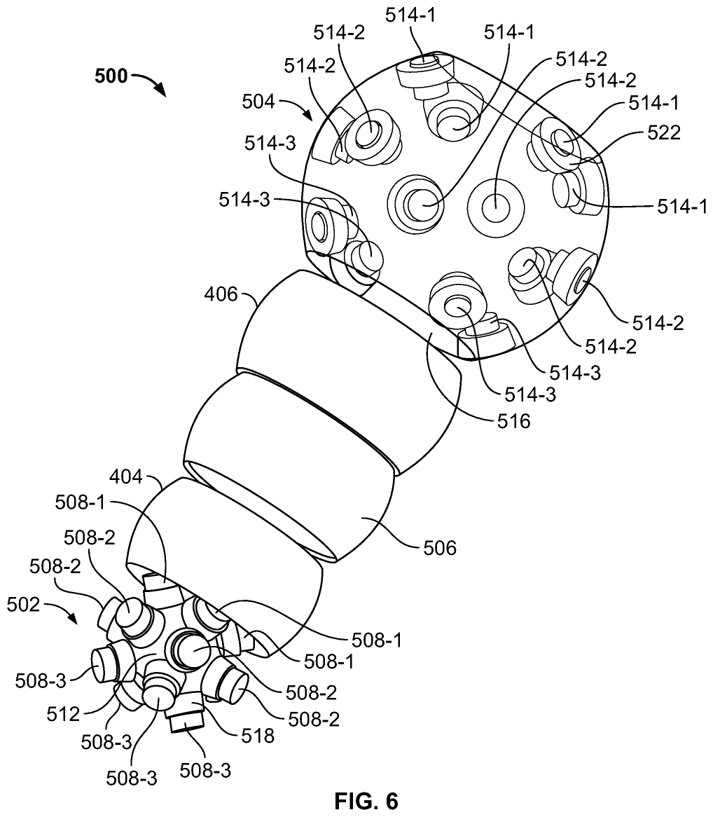

In another embodiment, which is depicted in FIGS. 5 and 6, the motor 500 also includes an inner stator 502, and outer stator 504, and a rotor 506. In this embodiment, however, the inner and outer stators 502, 504 each have a plurality of pole projections formed thereon. Specifically, the inner stator 502 has a plurality of inner stator pole projections 508 formed on its outer surface 512, and the outer stator 504 has a plurality of outer stator pole projections 514 formed on its inner surface 516. Each of the inner stator pole projections 508 extend radially outwardly from the outer surface 512 of the inner stator 502, and each of the outer stator pole projections 514 extend radially inwardly from the inner surface 516 of the outer stator 504.

In this embodiment, a plurality of concentric inner stator coils 518 are spirally wound around each inner stator pole projection 508, and a plurality of concentric outer stator coils 522 are spirally wound around each outer stator pole projection 514. More specifically, each inner stator pole projection 508 and one concentric inner stator coil 518 spirally wound around it. Similarly, each outer stator pole projection 514 has one concentric outer stator coil 522 are spirally wound around it.

As FIGS. 5 and 6 also depict, the inner and outer stators 502, 504 are configured differently than the inner and outer stators 102, 104 depicted in FIGS. 1-4. In particular, the inner and outer stators 502, 504 are configured as relatively smooth, hollow spherical bodies, and are preferably constructed of a magnetically permeable material such as, for example, relatively soft magnetic solid material, steel stampings/laminations, and molds made up of soft iron powder and/or composites. It will be appreciated, however, that the inner and outer stators 502, 504 could be configured similar to the embodiment depicted in FIGS. 1-4, and may thus include projected poles or have a slotted construction. The remainder of the motor 500 construction is the same as in previous embodiments, so no additional description is provided.

Furthermore, and FIG. 6 depicts more clearly, the inner stator pole projections 508 and the outer stator pole projections 514 are grouped into three sets. The first sets are referenced with “4”, the second sets are referenced with “−2”, and the third sets are referenced with “−3”. By energizing the stator coils 518, 522 wound on one or both of the first sets of stator projections 508-1, 514-1 and/or one or both of the stator coils 518, 522 wound on the third sets of stator projections 508-3, 514-3 with DC current, the rotor 506 will tilt about the tilt axis 203 (see FIG. 2). By energizing the stator coils 518, 522 wound on one or both of the second sets of stator projections 508-2, 514-2 with AC current, the rotor 506 will rotate about the spin axis 201 (see FIG. 2).

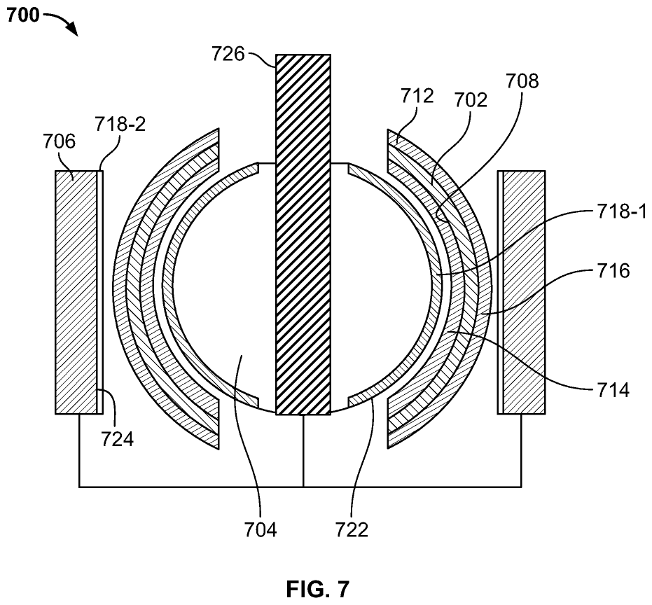

In yet another embodiment, which is depicted in FIG. 7, the multi-stage spherical motor 700 includes a single spherical stator 702, an inner rotor 704, and an outer rotor 706. The spherical stator 702 has a stator inner surface 708 and a stator outer surface 712. Inner stator coils 714 are wound on the stator inner surface 708, and outer stator coils 716 are wound on the stator outer surface 714. The stator inner surface 708 and the stator outer surface 712 may include projected poles or have a slotted construction, as previously described. If the stator inner and outer surfaces 708, 712 include slots, the inner and outer stator coils 714, 716 may each comprise distributed windings and a voice coil winding, as described above and depicted in FIGS. 2 and 3. If the stator inner and outer surfaces 708, 712 include projected poles, the inner and outer stator coils 714, 716 may each comprise concentric stator coils are spirally wound around each projection, as described above and depicted in FIGS. 5 and 6.

The inner rotor 704 and outer rotor 706 both have magnets 718 coupled thereto. The inner rotor 704 has an inner array of magnets 718-1 coupled to its outer surface 722, and the outer rotor 706 has an outer array of magnets 718-2 coupled to its inner surface 724. The inner and outer arrays of magnets 718 may be variously configured. For example, each may be configured as a Halbach array or as a non-Halbach. The inner and outer rotors 704, 706 are configured to both tilt and spin and are both coupled to a common load shaft 726.

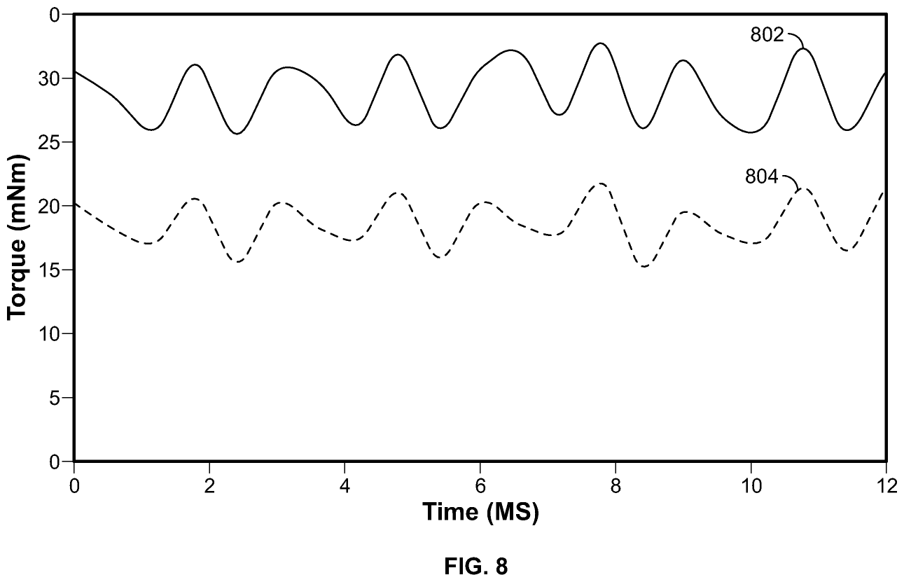

The multi-stage spherical motor embodiments disclosed herein exhibit several advantages over many presently known spherical motors. One advantage is a volumetric advantage, whereby the multi-stage configuration enables high power density spherical motor construction in a relatively small space envelope. The multi-stage spherical motor embodiments have less parts, thereby increasing overall reliability. The multi-stage spherical motor embodiments also exhibit relatively higher torque. For example, as FIG. 8 depicts, the multi-stage spherical motor embodiments 802 can deliver approximately 1.5 times that of presently known configurations 804.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, magnetically electronically, logically, or in any other manner, through one or more additional elements.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A multi-stage spherical motor, comprising:
an inner stator having a plurality of inner stator windings wound thereon;
an outer stator spaced apart from and at least partially surrounding the inner stator, the outer stator having a plurality of outer stator windings wound thereon;
a rotor disposed between the inner stator and the outer stator and configured to rotate about a plurality of perpendicular axes, the rotor having an inner surface and an outer surface;
an inner array of magnets coupled to the inner surface of the rotor; and
an outer array of magnets coupled to the outer surface of the rotor.

2. The multi-stage spherical motor of claim 1, wherein:
the plurality of inner stator windings comprise (i) a plurality of inner stator distributed windings and (ii) an inner stator voice coil winding; and
the plurality of outer stator windings comprise (i) a plurality of outer stator distributed windings and (ii) an outer stator voice coil winding wound thereon.

3. The multi-stage spherical motor of claim 2, wherein:
the inner stator voice coil winding is disposed on an outer surface of the inner stator; and
the outer stator voice coil winding is disposed on an inner surface of the outer stator.

4. The multi-stage spherical motor of claim 2, wherein:
the inner stator comprises an inner stator iron backing and a plurality of arc-shaped inner stator poles, each arc-shaped inner stator pole connected to the inner stator iron backing; and
the outer stator comprises an outer stator iron backing and a plurality of arc-shaped outer stator poles, each arc-shaped outer stator pole connected to the outer stator iron backing.

5. The multi-stage spherical motor of claim 4, wherein:
the inner stator iron backing comprises an inner main body and a plurality of inner spokes extending radially outwardly from the inner main body, the inner spokes spaced apart from each other to define a plurality of inner stator slots;
each arc-shaped inner stator pole is connected to a different one of the inner spokes;
the outer stator iron backing comprises an outer main body and a plurality of outer spokes extending radially inwardly from the outer main body, the outer spokes spaced apart from each other to define a plurality of outer stator slots; and
each arc-shaped outer stator pole is connected to a different one of the outer spokes.

6. The multi-stage spherical motor of claim 6, wherein:
the inner stator distributed windings extend through the inner stator slots; and
the outer stator distributed windings extend through the outer stator slots.

7. The multi-stage spherical motor of claim 6, wherein:
each arc-shaped inner stator pole has an outer surface;
each arc-shaped outer stator pole has an inner surface;
the inner stator voice coil winding is wound onto and around the outer surfaces of the arc-shaped inner stator poles; and
the outer stator voice coil winding is wound onto and around the inner surfaces of the arc-shaped outer stator poles

8. The multi-stage spherical motor of claim 2, wherein:
the inner and outer stator distributed windings, when energized, impart a torque to the rotor that causes the rotor to rotate, relative to the inner and outer stators, about a first rotational axis; and
the inner and outer stator voice coil windings, when energized, impart a torque to the rotor that causes the rotor to rotate, relative to the inner and outer stators, about a second rotational axis that is perpendicular to the first rotational axis.

9. The multi-stage spherical motor of claim 1, wherein:
the inner stator comprises a plurality of inner stator pole projections, each inner stator pole projection extending radially outwardly from an outer surface of the inner stator; and
the outer stator comprises a plurality of outer stator pole projections, each outer stator pole projection extending radially inwardly from an inner surface of the outer stator.

10. The multi-stage spherical motor of 9, wherein:
the inner stator windings comprise a plurality of concentric inner stator coils, each concentric inner stator coil spirally wound around at least a portion of the inner stator pole projections;
the outer stator windings comprise a plurality of concentric outer stator coils, each concentric outer stator coil spirally wound around at least a portion of the outer stator pole projections.

11. The multi-stage spherical motor of claim 10, wherein:
the concentric inner stator coils comprise three sets of coils wound orthogonal to each other; and
the concentric outer stator coils comprise three sets of coils wound orthogonal to each other.

12. A multi-stage spherical motor, comprising:
an inner rotor configured to rotate and having an inner surface and an outer surface;
an outer rotor spaced apart from and at least partially surrounding the inner rotor, the outer rotor configured to rotate with the inner rotor and having an inner surface and an outer surface;
an inner array of magnets coupled to the outer surface of the inner rotor;
an outer array of magnets coupled to the inner surface of the outer rotor;
a stator disposed between the inner rotor and the outer rotor, the stator having a stator inner surface and a stator outer surface;
inner stator coils wound on the stator inner surface; and
outer stator coils are wound on the stator outer surface.

13. The multi-stage spherical motor of claim 12, further comprising:
a plurality of inner stator pole projections, each inner stator pole projection extending radially inwardly from the stator inner surface; and
a plurality of outer stator pole projections, each outer stator pole projection extending radially outwardly from the stator outer surface.

14. The multi-stage spherical motor of claim 13, wherein:
the inner stator coils comprise a plurality of concentric inner stator coils, each concentric inner stator coil spirally wound around at least a portion of the inner stator pole projections;
the outer stator coils comprise a plurality of concentric outer stator coils, each concentric outer stator coil spirally wound around at least a portion of the outer stator pole projections.

15. The multi-stage spherical motor of claim 14, wherein:
the concentric inner stator coils comprise three sets of coils wound orthogonal to each other; and
the concentric outer stator coils comprise three sets of coils wound orthogonal to each other.

16. A multi-stage spherical motor, comprising:
an inner stator having a plurality of inner stator windings wound thereon, the inner stator comprising an inner stator iron backing and a plurality of arc-shaped inner stator poles, each arc-shaped inner stator pole connected to the inner stator iron backing;
an outer stator spaced apart from and at least partially surrounding the inner stator, the outer stator having a plurality of outer stator windings wound thereon, the outer stator comprises an outer stator iron backing and a plurality of arc-shaped outer stator poles, each arc-shaped outer stator pole connected to the outer stator iron backing;
a rotor disposed between the inner stator and the outer stator and configured to rotate about a plurality of perpendicular axes, the rotor having an inner surface and an outer surface;
an inner array of magnets coupled to the inner surface of the rotor; and
an outer array of magnets coupled to the outer surface of the rotor,
wherein:
the plurality of inner stator windings comprise (i) a plurality of inner stator distributed windings and (ii) an inner stator voice coil winding,
the plurality of outer stator windings comprise (i) a plurality of outer stator distributed windings and (ii) an outer stator voice coil winding wound thereon,
the inner stator voice coil winding is disposed on an outer surface of the inner stator, and
the outer stator voice coil winding is disposed on an inner surface of the outer stator.

17. The multi-stage spherical motor of claim 16, wherein:
the inner stator iron backing comprises an inner main body and a plurality of inner spokes extending radially outwardly from the inner main body, the inner spokes spaced apart from each other to define a plurality of inner stator slots;
each arc-shaped inner stator pole is connected to a different one of the inner spokes;
the outer stator iron backing comprises an outer main body and a plurality of outer spokes extending radially inwardly from the outer main body, the outer spokes spaced apart from each other to define a plurality of outer stator slots; and
each arc-shaped outer stator pole is connected to a different one of the outer spokes.

18. The multi-stage spherical motor of claim 17, wherein:
the inner stator distributed windings extend through the inner stator slots; and
the outer stator distributed windings extend through the outer stator slots.

19. The multi-stage spherical motor of claim 18, wherein:
each arc-shaped inner stator pole has an outer surface;
each arc-shaped outer stator pole has an inner surface;
the inner stator voice coil winding is wound onto and around the outer surfaces of the arc-shaped inner stator poles; and
the outer stator voice coil winding is wound onto and around the inner surfaces of the arc-shaped outer stator poles

20. The multi-stage spherical motor of claim 16, wherein:
the inner and outer stator distributed windings, when energized, impart a torque to the rotor that causes the rotor to rotate, relative to the inner and outer stators, about a first rotational axis; and
the inner and outer stator voice coil windings, when energized, impart a torque to the rotor that causes the rotor to rotate, relative to the inner and outer stators, about a second rotational axis that is perpendicular to the first rotational axis.
